(19) United States
(12) Patent Application Publication
(10) Pub. No.: US 2023/0384107 A1
(43) Pub. Date: Nov. 30, 2023

(54) SYSTEM FOR VEHICLE ROUTE OPTIMIZATION USING VISIBILITY CONDITION

(71) Applicant: FORD GLOBAL TECHNOLOGIES, LLC, Dearborn, MI (US)

(72) Inventors: Stuart C. SALTER, White Lake, MI (US); Brendan F. DIAMOND, Grosse Pointe, MI (US); Annette Lynn HUEBNER, Highland, MI (US); Pietro BUTTOLO, Dearborn Heights, MI (US); Lucretia WILLIAMS, Bloomfield Hills, MI (US)

(21) Appl. No.: 17/751,939

(22) Filed: May 24, 2022

(51) Int. Cl. G01C 21/34; G01C 21/36; B60W 30/12; B60W 30/14; B60Q 1/14; G01J 1/42

(52) U.S. Cl. CPC G01C 21/3484; G01C 21/3691; B60W 30/12; B60W 30/146; B60Q 1/14; G01J 1/42; H04L 67/10

(57) ABSTRACT

A vehicle includes a controller programmed to responsive to receiving a destination, plan a plurality of routes to the destination, obtain visibility condition data for at least a part of each of the routes, anticipate an activation of a driving assistance feature in a section of at least one of the routes using the visibility condition data, and responsive to arriving at the section, activate the driving assistance feature while the vehicle is being manually driven by a user.

### TECHNICAL FIELD

The present disclosure generally relates to a vehicle system. More specifically, the present disclosure relates to a system for optimizing vehicle route planning and performing vehicle operations based on light and visibility conditions.

### BACKGROUND

When a vehicle operates at night, light and visibility conditions are generally reduced compared to operating at daytime. Vehicle drivers may have a variety of light and visibility preferences to optimize the operations of the vehicle. For instance, an older driver may prefer a route having better lighting and visibility compared with a younger driver while operating the vehicle at night.

### SUMMARY

In one or more illustrated embodiments of the present disclosure, a vehicle includes a controller programmed to responsive to receiving a destination, plan a plurality of routes to the destination, obtain visibility condition data for at least a part of each of the routes, anticipate an activation of a driving assistance feature in a section of at least one of the routes using the visibility condition data, and responsive to arriving at the section, activate the driving assistance feature while the vehicle is being manually driven by a user.

In one or more illustrated embodiments of the present disclosure, a method for a vehicle includes responsive to identifying a trip, planning a plurality of routes to for the trip; obtaining light condition data and visibility condition data for at least a part of each of the routes from a server; obtaining a user profile associated with a user, the user profile being indicative a night driving preference of the user; and selecting one of the routes for navigation based on the user profile, the light condition data and the visibility condition data.

In one or more illustrated embodiments of the present disclosure, a non-transitory computer-readable medium includes instructions, when executed by a vehicle, cause the vehicle to responsive to receiving a destination, plan a plurality of routes to the destination; obtain light condition data and visibility condition data for at least a part of each of the routes; output the plurality of routes, the light condition data and the visibility condition data to a user; responsive to receiving a manual selection by the user, provide navigation instructions for one of the routes as selected; anticipate an activation of a driving assistance feature in a section of at least one of the routes using the visibility condition data; and responsive to arriving at the section, activate the driving assistance feature while the vehicle is being manually driven by the user.

### BRIEF DESCRIPTION OF THE DRAWINGS

For a better understanding of the invention and to show how it may be performed, embodiments thereof will now be described, by way of non-limiting example only, with reference to the accompanying drawings, in which:

FIG. 1 illustrates an example block topology of a vehicle system of one embodiment of the present disclosure;

FIG. 2 illustrates a flow diagram of a process for planning routes and operating the vehicle of one embodiment of the present disclosure; and

FIG. 3 illustrates a schematic diagram of the vehicle system of one embodiment of the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The present disclosure generally provides for a plurality of circuits or other electrical devices. All references to the circuits and other electrical devices, and the functionality provided by each, are not intended to be limited to encompassing only what is illustrated and described herein. While particular labels may be assigned to the various circuits or other electrical devices, such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programed to perform any number of the functions as disclosed.

The present disclosure, among other things, proposes a vehicle system to accommodate various driving conditions at night. More specifically, the present disclosure proposes a vehicle system for planning route and operating a vehicle using light and visibility conditions on various routes.

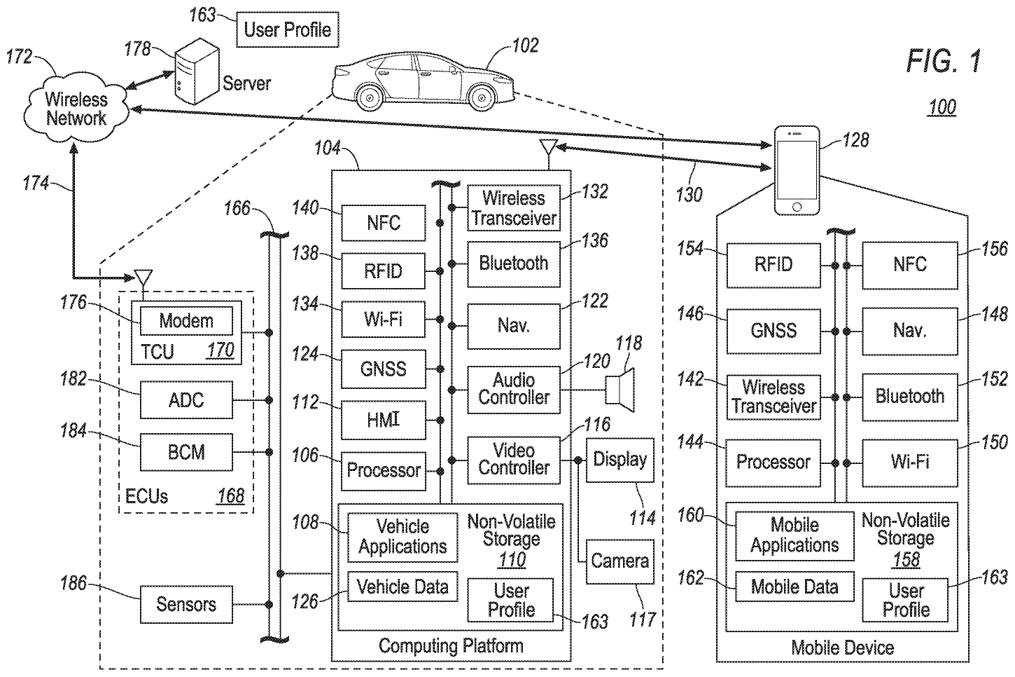

Referring to FIG. 1, an example block topology of a vehicle system 100 of one embodiment of the present disclosure is illustrated. A vehicle 102 may include various types of automobile, crossover utility vehicle (CUV), sport utility vehicle (SUV), truck, recreational vehicle (RV), boat, plane, or other mobile machine for transporting people or goods. In many cases, the vehicle 102 may be powered by an internal combustion engine. As another possibility, the vehicle 102 may be a battery electric vehicle (BEV), a hybrid electric vehicle (HEV) powered by both an internal combustion engine and one or move electric motors, such as a series hybrid electric vehicle (SHEV), a plug-in hybrid electric vehicle (PHEV), a parallel/series hybrid vehicle (PSHEV), or a fuel-cell electric vehicle (FCEV), a boat, a plane or other mobile machine for transporting people or goods. It should be noted that the illustrated system 100 is merely an example, and more, fewer, and/or differently located elements may be used.

As illustrated in FIG. 1, a computing platform 104 may include one or more processors 106 configured to perform instructions, commands, and other routines in support of the processes described herein. For instance, the computing platform 104 may be configured to execute instructions of vehicle applications 108 to provide features such as navigation, vehicle controls, and wireless communications. Such instructions and other data may be maintained in a non-volatile manner using a variety of types of computer-readable storage medium 110. The computer-readable medium 110 (also referred to as a processor-readable medium or storage) includes any non-transitory medium (e.g., tangible medium) that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++,C#, Objective C, Fortran, Pascal, Java Script, Python, Perl, and structured query language (SQL).

The computing platform 104 may be provided with various features allowing the vehicle occupants/users to interface with the computing platform 104. For example, the computing platform 104 may receive input from human machine interface (HMI) controls 112 configured to provide for occupant interaction with the vehicle 102. As an example, the computing platform 104 may interface with one or more buttons, switches, knobs, or other HMI controls configured to invoke functions on the computing platform 104 (e.g., steering wheel audio buttons, a push-to-talk button, instrument panel controls, etc.).

The computing platform 104 may also drive or otherwise communicate with one or more displays 114 configured to provide visual output to vehicle occupants by way of a video controller 116. In some cases, the display 114 may be a touch screen further configured to receive user touch input via the video controller 116, while in other cases the display 114 may be a display only, without touch input capabilities. The computing platform 104 may also drive or otherwise communicate one or more cameras 117 configured to capture image or video input by way of the video controller 116. The one or more cameras 117 may include a dashboard camera configured to capture images ahead of the vehicle. Additionally or alternatively, the one or more cameras 117 may include a cabin camera facing the driver or passengers configured to capture images within the vehicle cabin. The computing platform 104 may also drive or otherwise communicate with one or more speakers 118 configured to provide audio output and input to vehicle occupants by way of an audio controller 120.

The computing platform 104 may also be provided with navigation and route planning features through a navigation controller 122 configured to calculate navigation routes responsive to user input via e.g., the HMI controls 112, and output planned routes and instructions via the speaker 118 and the display 114. Location data that is needed for navigation may be collected from a global navigation satellite system (GNSS) controller 124 configured to communicate with multiple satellites and calculate the location of the vehicle 102. The GNSS controller 124 may be configured to support various current and/or future global or regional location systems such as global positioning system (GPS), Galileo, Beidou, Global Navigation Satellite System (GLONASS) and the like. Map data used for route planning may be stored in the storage 110 as a part of the vehicle data 126. Navigation software may be stored in the storage 110 as one the vehicle applications 108.

The computing platform 104 may be configured to wirelessly communicate with a mobile device 128 of the vehicle users/occupants via a wireless connection 130. The mobile device 128 may be any of various types of portable computing devices, such as cellular phones, tablet computers, wearable devices, smart watches, smart fobs, laptop computers, portable music players, or other device capable of communication with the computing platform 104. A wireless transceiver 132 may be in communication with a Wi-Fi controller 134, a Bluetooth controller 136, a radio-frequency identification (RFID) controller 138, a near-field communication (NFC) controller 140, and other controllers such as a Zigbee transceiver, an IrDA transceiver, and configured to communicate with a compatible wireless transceiver 142 of the mobile device 128.

The mobile device 128 may be provided with a processor 144 configured to perform instructions, commands, and other routines in support of the processes such as navigation, telephone, wireless communication, and multi-media processing. For instance, the mobile device 128 may be provided with location and navigation functions via a GNSS controller 146 and a navigation controller 148. The mobile device 128 may be provided with a wireless transceiver 142 in communication with a Wi-Fi controller 150, a Bluetooth controller 152, a RFID controller 154, an NFC controller 156, and other controllers (not shown), configured to communicate with the wireless transceiver 132 of the computing platform 104. The mobile device 128 may be further provided with a non-volatile storage 158 to store various mobile application 160 and mobile data 162. The non-volatile storage 158 may be further configured to store a user profile 163 indicative of information associated with a mobile device user. (To be discussed in detail below.) The computing platform 104 may be configured to obtain the user profile 163 from the mobile device 128 via the wireless connection 130 and store the user profile 163 in the non-volatile storage 110. Additionally, the user profile 163 may be shared across various devices associated with the user via the cloud server 178.

The computing platform 104 may be further configured to communicate with various components of the vehicle 102 via one or more in-vehicle network 166. The in-vehicle network 166 may include, but is not limited to, one or more of a controller area network (CAN), an Ethernet network, and a media-oriented system transport (MOST), as some examples. Furthermore, the in-vehicle network 166, or portions of the in-vehicle network 166, may be a wireless network accomplished via Bluetooth low-energy (BLE), Wi-Fi, ultra-wide band (UWB) or the like.

The computing platform 104 may be configured to communicate with various electronic control units (ECUs) 168 of the vehicle 102 configured to perform various operations. For instance, the computing platform 104 may be configured to communicate with a telematics control unit (TCU) 170 configured to control telecommunication between vehicle 102 and a wireless network 172 through a wireless connection 174 using a modem 176. The wireless connection 174 may be in the form of various communication network e.g., a cellular network. Through the wireless network 172, the vehicle may access one or more servers 178 to access various content for various purposes. It is noted that the terms wireless network and server are used as general terms in the present disclosure and may include any computing network involving carriers, router, computers, controllers, circuitry or the like configured to store data and perform data processing functions and facilitate communication between various entities. The ECUs 168 may further include an autonomous driving controller (ADC) 182 configured to control autonomous driving features or driving assistance features of the vehicle 102. In one example, ADC 182 may be provided with full autonomous driving features that enables autonomous driving with no or little driver input. Additionally or alternatively, the ADC 182 may be provided with limited autonomous driving features such as adaptive cruise control, lane departure message, lane keep assist, to assistance a driver operating the vehicle 102. Driving instructions may be received remotely from the server 178. The ADC 182 may be configured to perform the autonomous driving features using the driving instructions combined with navigation instructions from the navigation controller 122. The ECUs 168 may be further provided with a body control module (BCM) 184 configured to operate vehicle body functions of the vehicle 102. For instance, the BCM 184 may be configured to automatically control the vehicle lighting such as automatic headlight and/or automatic high beam light based on the driving condition.

The vehicle 102 may be provided with various sensors 184 to provide signal input to the computing platform 104 and the ECUs 168. As a few non-limiting examples, the sensors 184 may include one or more cameras configured to capture images of the outside environment. The sensors 184 may further include one or more ultra-sonic radar sensors and/or lidar sensors to detect object at the vicinity of the vehicle 102. The sensors 184 may further include one or more light sensors to detect and measure light intensity of the outside environment of the vehicle 102.

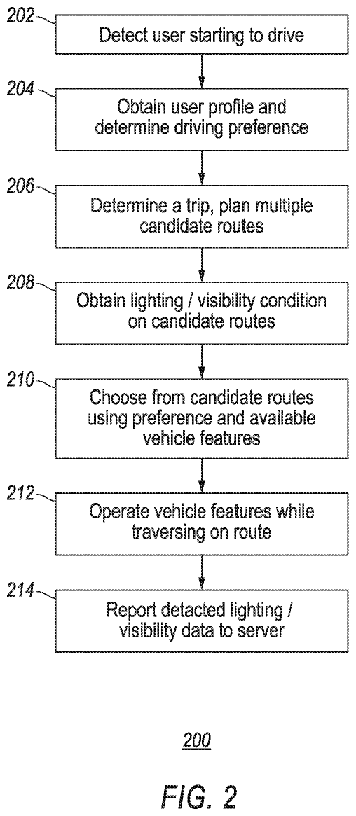

Referring to FIG. 2, an example flow diagram of a process 200 for planning routes and operating the vehicle of one embodiment of the present disclosure is illustrated. With continuing reference to FIG. 1, the process 200 may be implemented via one or more components of the vehicle 102. For instance, the process 200 may be implemented via the computing platform 104 individually or in combination with one or more ECUs 168. For simplicity, the following description will be made with reference to the computing platform 104 although other components of the vehicle 102 may be used in lieu of or in addition to the computing platform 104 to perform the process 200 under essentially the same concept. Responsive to detecting a user starting or planning to drive the vehicle 102 at operation 202, the process proceeds to operation 204 and the computing platform 104 obtains a user profile 163 associated with the user and determines driving preferences using the user profile 163. As discussed above, there are a variety of method to obtain the user profile 163. As a few non-limiting examples, the computing platform 104 may obtain the user profile 163 from the mobile device 128 associated with the user via the wireless connection 130. Additionally or alternatively, the computing platform 104 may obtain the user profile 163 from the server 178 responsive to identifying the driver. Additionally or alternatively, the computing platform 104 may already had the user profile 163 stored in the non-volatile storage 110. The computing platform 104 may identify the user using the user profile 163. Additionally or alternatively, responsive to the user entering the vehicle, the computing platform 104 may capture a facial image of the user in the driver location and recognize the identity using facial recognition technologies. Correctly identifying the driver may be particularly useful in case that multiple users (including the driving and passengers) are using the vehicle at the same time and depending on which user drives the vehicle the computing platform 104 may operate differently. The user profile 163 may include various information associated with the user driving the vehicle 102. For instance, the user profile 163 may include age, visual impairment, eyesight or the like that are indicative of a visual condition of the user. The user profile 163 may further include driver records (e.g. previous driving event at night) and historical driving routes that are indicative of a driver familiarity of one or more routes to be planned. (To be discussed in detail below.) Based on the user profile 163, the computing platform 104 may determine a driving preference indicative of a user preference for night driving condition (including light and visibility conditions). The night driving preference may be determined and quantified in the form of a score wherein a higher score may be indicative of a higher degree of tolerance for poor night driving condition and a lower score may be indicative of a lower degree of tolerance for poor night driving condition.

At operation 206, the computing platform 104 determines a trip associated with the user driving the vehicle 102 and plans a plurality of candidate routes for the trip via the navigation controller 122. The trip may be an immediate trip based on manually input via the HMI controls 112. Additionally or alternatively, the trip may be determined based on historic travelling pattern or an event in the user calendar accessible by the computing platform 104. At operation 208, the computing platform 104 obtains information with regard to the light condition and visibility condition on the plurality of candidate routes. The light condition may be indicative of a degree and intensity of light on the route influenced by various factors including time of the day, infrastructure condition (e.g. road lamps), traffic condition, environment building lighting, or the like. The visibility condition may be indicative of a degree of capability that the user is able to identify distinct features on a roadway that is required to operate the vehicle. The visibility condition may be affected by various factors including, but not limited to, roadway signage condition, lane marker condition, curvature of the road, presence of other vehicles, road imperfections (e.g. potholes), weather (e.g. rain, fog) or the like. The visibility condition may be assessed and determined via artificial intelligence (AI) and/or machine learning (ML) algorithms regarding how easily the vehicle sensors 186 (e.g. a camera) can identify those features of the road under the corresponding light condition. The light condition and visibility condition may be captured and shared in a crowd-sourced manner. For instance, a plurality of fleet vehicles may be subscribed to the system discussed in the present disclosure to capture and share sensor data with each other via the cloud server 178.

Having had the light and visibility conditions for each candidate route determined, at operation 210, the computing platform 104 selects one from the candidate routes using the driving preference to recommend to the vehicle user. The route selection result may be further affected by the availability of driving assistance features anticipated to be used on the route. For instance, the computing platform 104 may be further configured to anticipate the activation of one or more driving assistance features such as auto high beam light, lane keep assist features in one or more sections of the candidate routes based on the light and visibility conditions. The availability of the corresponding vehicle features may increase the chance of such a route being selected from the plurality of candidates. In an alternative example, instead of automatically selecting from the candidates, the computing platform 104 may present the routes along with the corresponding information to the user via the display 114 and ask the user to make the selection via the HMI controls 112. At operation 212, once the route for the trip is selected, the computing platform 104 or the ECUs 168 operate the corresponding vehicle assistance features at the corresponding section of the route to provide assistance to the driver. While traversing one the route, the vehicle 102 continuously capture data reflecting the exterior environment via one or more sensors 186. The data may be analyzed to determine the light condition and visibility condition at the corresponding section on the route. Additionally, the computing platform 104 may update the user profile 163 and share the updated user profile with the mobile device 128. At operation 214, the computing platform 104 upload light and visibility condition to the server 178 to contribute to the system.

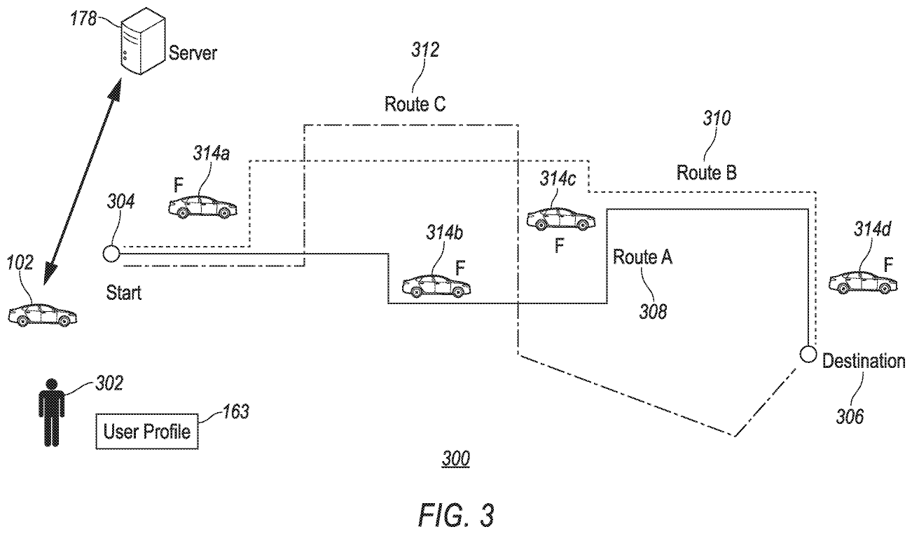

The operations of process 200 may be applied to various situations. Referring to FIG. 3, a schematic diagram 300 of an application of the process 200 of one embodiment of the present disclosure is illustrated. With continuing reference to FIGS. 1 and 2, responsive to detecting an immediate or planned trip having a starting location 304 and a destination 306 for a vehicle user 302, the computing platform 104 of the vehicle 102 plans a plurality of routes for the trip. Table 1 illustrates information related to the trip in the present example.

TABLE 1
Trip information
Trip Information

| Starting Location | Address A | |
|---|---|---|
| Destination | Address B | |
| Starting Time | 11:00 PM | |
| Date | Apr. 26, 2022 | |
| Weather | Light Rain | |
| Allowed Time Penalty | 15 | mins |
| Allowed Distance Penalty | 5 | miles |

As discussed above, one or more entries of the trip information illustrated in Table 1 may be automatically determined by the computing platform 104 using data such as user calendar, historic trips, previous settings or the like. Additionally or alternatively, the user 302 may manually input one or more entries of the trip information to the computing platform 104 via the HMI controls 112. The trip may be an immediate trip which uses the present time as the starting time. Otherwise, if the trip is planned for the near future, the planned date and time may be used for starting time. Since the light and visibility conditions may be affect by the weather, the computing platform 104 may obtain the weather information from the cloud server 178. The allowed time penalty entry is indicative of a maximum allowance of increased time from trip duration of the fastest/shortest route for an alternative route to be considered as a candidate. Similarly, the allowed distance penalty is indicative of a maximum allowance of increased distance from the fastest/shortest route for an alternative route to be considered as a candidate. The computing platform 104 may generate a plurality of candidate routes via the navigation controller 122 using the trip information. As illustrated with reference to FIG. 3, there are 3 routes, in total, that qualify as candidates based on the trip information, Route A 308, Route B 310, and Route C 312.

Responsive to qualifying the above 3 candidate routes, the computing platform 104 may determines the light condition and visibility condition on each candidate route. As discussed above, the computing platform 104 may download the data indicative of the light and visibility conditions from the cloud server 178. The light and visibility condition data may be collected via one or more fleet vehicles 134a to 134d currently or previously located at one or more sections of the candidate routes. Additionally or alternatively, the vehicle 102 may be configured to obtain the light and visibility condition data directly from the one or more fleet vehicles via a vehicle-to-vehicle (V2V) connection such as dedicated short-range communications (DSRC), cellular vehicle-to-everything (CV2X) connections or the like. The fleet vehicles 314 may include any vehicle and devices provided with light sensor and visibility analysis capability and subscribed to the system of the present disclosure. For instance, the fleet vehicles 314 may include one or more vehicle manufactured by the same manufacturer as the vehicle 102. Additionally or alternatively, the fleet vehicle 314 may include a vehicle that is provided with a computing device and sensors enabling the sensing and processing of the light condition and visibility condition data as discussed in the present disclosure. Additionally or alternatively, the fleet vehicle 314 may include a non-vehicular device provided with a computing device and sensors enabling the sensing and processing of the light condition and visibility condition data, such as a smart phone, smart glasses, smart watch or the like. With the light and visibility conditions for each candidate route determined, the computing platform 104 may generate route information for each candidate to facilitate the route selection. Table 2 illustrates an example route information table.

TABLE 2
Route information

| | Penalty | | Roadway Condition | |
|---|---|---|---|---|
| | Time (min) | Distance (mile) | Light | Visibility |
| Route A | 0 | 0 | 6 | 4 |
| Route B | 10 | 3 | 9 | 9 |
| Route C | 5 | 5 | 8 | 6 |

In the present example, Route A 308 is the shortest and fastest route that is used as a reference route for penalty calculations. Despite the short distance, Route A 308 (e.g. country road) is associated with relatively low light condition and visibility condition. The light and visibility conditions may be presented in the form of a scores from 0 to 10 in the present example, although other methods may be used to quantify the conditions. Route B 310 (e.g. city road) has the best light and visibility conditions but the route is also associated with the greatest time penalty. Route C 312 (e.g. mixed city and country road) has medium light and visibility conditions and medium penalties. In one example, the computing platform 104 may output data entries from Table 2 via the display 114 and ask the user to manually select one from the three candidates. Alternatively, the computing platform 104 may automatically make the selection based on the user profile 163 and driving preference score without relying on user input. For a user with a relatively high driving preference score indicative of a high degree of tolerance to poor light and visibility condition, the computing platform 104 may automatically select Route A 308 to save the travel time. Alternatively, for a user with a relatively low driving preference score indicative of a low degree of tolerance, the computing platform 104 may automatically select Route B 310 associated with the best light and visibility conditions. Alternatively, for a user with medium driving preference, the computing platform 104 may automatically select Route C 312 which is balanced between the roadway conditions and penalties.

As discussed above, the computing platform 104 may be further configured to anticipate usage of vehicle features in one or more sections of the routes. For instance, responsive to the lack of or unclear central lane markers in a section of roadway according to the visibility condition, the computing platform 104 may anticipate the automatic activation of lane keep assist feature enabled by the location data from the GNSS controller 124. In another example, if the visibility condition indicates poor visibility of road signs such as speed limit signs on a section of the road, the computing platform 104 may automatically active an electronic speed limiter once the vehicle 102 arrives at the corresponding section. the electronic speed limiter may also be activated in response to poor road conditions (e.g. potholes). In another example, the computing platform 104 may anticipate the activation of auto high beam light due to poor light condition and little oncoming traffic. If the vehicle 102 is provided the features that are anticipated to be activated during the trip, the computing platform 104 may also take those features into account while automatically selecting from the candidate routes. Once the route is selected, the computing platform 104 may output navigation instructions via the HMI controls 112 to direct the user traversing on the selected route. In addition, the computing platform may automatically activate the anticipated vehicle features once arrived at the corresponding section on the route.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. The words processor and processors may be interchanged herein, as may the words controller and controllers.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle, comprising:
a controller programmed to
responsive to receiving a destination, plan a plurality of routes to the destination,
obtain visibility condition data for at least a part of each of the routes,
anticipate an activation of a driving assistance feature in a section of at least one of the routes using the visibility condition data, and
responsive to arriving at the section, activate the driving assistance feature while the vehicle is being manually driven by a user.

2. The vehicle of claim 1, wherein the controller is further programmed to:
obtain a user profile associated with the user, the user profile being indicative of at least one of: an age of the user, or a driving history in an area at least partially overlapping one of the routes; and
automatically select one of the routes for navigation based on the user profile.

3. The vehicle of claim 2, wherein the controller is further programmed to:
automatically select one of the routes for navigation further based on the driving assistance feature as anticipated that is available to vehicle.

4. The vehicle of claim 1, wherein the controller is further programmed to:
output the plurality of routes and the visibility condition data to the user; and
responsive to receiving a manual selection by the user, provide navigation for one of the routes as selected.

5. The vehicle of claim 1, wherein the visibility condition data is indicative of at least one of: visibility of a sign, or visibility of a lane marker.

6. The vehicle of claim 1, wherein the visibility condition data is indicative of at least one of: road curvature, or road imperfections.

7. The vehicle of claim 1, wherein the controller is further programmed to obtain light condition data indicative of an intensity of light for at least a part of each of the routes.

8. The vehicle of claim 7, further comprising:
one or more sensors configured to measure the visibility condition data and the light condition data.

9. The vehicle of claim 8, further comprising:
one or more transceivers configured to obtain the visibility condition data from a remote server.

10. The vehicle of claim 9, wherein the one or more transceivers are further configured to obtain the visibility condition data from a fleet via a direct link.

11. The vehicle of claim 1, wherein the driving assistance feature includes at least one of: lane keep assist, automatic high beam light, or speed limiter.

12. A method for a vehicle comprising:
responsive to identifying a trip, planning a plurality of routes to for the trip;
obtaining light condition data and visibility condition data for at least a part of each of the routes from a server;
obtaining a user profile associated with a user, the user profile being indicative a night driving preference of the user; and
selecting one of the routes for navigation based on the user profile, the light condition data and the visibility condition data.

13. The method of claim 12, further comprising:
anticipating an activation of a driving assistance feature in a section of at least one of the routes using the light condition data and the visibility condition data;
selecting one of the routes for navigation further based on the driving assistance feature as anticipated that is available to vehicle; and
responsive to arriving at the section, activating the driving assistance feature while the vehicle is being manually driven by the user.

14. The method of claim 12, further comprising:
obtaining the light condition data and the visibility condition data from a fleet via a direct wireless link.

15. The method of claim 12, further comprising:
measuring the visibility condition data and the light condition data while traversing on one of the routes selected; and
sending the visibility condition data and the light condition data to a server.

16. The method of claim 12, wherein the visibility condition data is indicative of: visibility of a sign, or visibility of a lane marker.

17. A non-transitory computer-readable medium comprising instructions, when executed by a vehicle, cause the vehicle to:
responsive to receiving a destination, plan a plurality of routes to the destination;
obtain light condition data and visibility condition data for at least a part of each of the routes;
output the plurality of routes, the light condition data and the visibility condition data to a user;
responsive to receiving a manual selection by the user, provide navigation instructions for one of the routes as selected;
anticipate an activation of a driving assistance feature in a section of at least one of the routes using the visibility condition data; and
responsive to arriving at the section, activate the driving assistance feature while the vehicle is being manually driven by the user.

18. The non-transitory computer-readable medium of claim 17, further comprising instructions, when executed by a vehicle, cause the vehicle to:
measure the visibility condition data and the light condition data while traversing on one of the routes selected; and
send the visibility condition data and the light condition data to a server.

19. The non-transitory computer-readable medium of claim 17, wherein the visibility condition data is indicative of: visibility of a sign, or visibility of a lane marker.

20. The non-transitory computer-readable medium of claim 17, further comprising instructions, when executed by a vehicle, cause the vehicle to:
obtain a user profile associated with the user from a mobile device, the user profile being indicative a night driving preference of the user; and
automatically select one of the routes for navigation based on the user profile, the light condition data and the visibility condition data.
